(19) United States
(12) Patent Application Publication
(10) Pub. No.: US 2015/0296139 A1
(43) Pub. Date: Oct. 15, 2015

(54) Mobile communication device multidirectional/wide angle camera lens system

(71) Applicant: TIMOTHY ONYENOBI, MANCHESTER (GB)

(72) Inventor: TIMOTHY ONYENOBI, MANCHESTER (GB)

(21) Appl. No.: 14/251,277

(22) Filed: Apr. 11, 2014

(51) Int. Cl. H04N 5/232

(52) U.S. Cl. CPC H04N 5/23238

(57) ABSTRACT

A mobile communication device multidirectional/wide angle camera lens system where the mobile communication device 3, 4 has a camera that captures a traditional view 2 and a panoramic view 1 of the scene directly facing the camera either by the use of the camera's lens 7, 8, 10, 11 or through a system of lenses 7, 9, 12; where either one of these lenses are embedded within an enclosure on the surface of the mobile communication device 5, 6 or they can be projected beyond the surface of the mobile communication device 5, 6 from an enclosure; to capture a wide angle or panoramic view larger than that which is possible from the camera of a traditional mobile communication device with a fixed unidirectional camera lens allowing for implementation of a wider angle capture content which can be a full panoramic view or a view limited by an angle as desired by the user of the mobile communication device.

### BACKGROUND OF THE INVENTION

The present invention is in the field of mobile communication devices. it is a mobile communication device multi directional/wide angle camera lens system (projecting or non-projecting/protruding from mobile communication device) which relates to a camera or system of cameras (enclosed or not enclosed) which could either be fixed or retractable (manually or automatically), such that mobile communication device users as a result are able to have a much wider cone of vision either in a single capture or by directing the live camera capture lens using a software program within the mobile communication device. This Mobile communication device multidirectional/wide angle camera lens system can be located on any part of the mobile communication device.

Mobile communication device camera is used for various purposes and since the 21^{st} century and is becoming more widely used and gradually replacing the traditional unidirectional hand held camera. The consumer demand for mobile communication device camera has also increased greatly due to the increased quality of still photograph and live video capture and especially as the mobile communication device camera can be integrated and/or interfaced with mobile communication device applications. The mobile communication device camera has been harnessed to enhance phone communication using numerous video/voice communication applications. The traditional mobile communication device camera has made possible numerous mobile communication device application (APP) programmed to harness the mobile communication device camera potential. Though the mobile communication device camera is able to provide a highly important mobile communication device hardware benefits for numerous mobile communication device applications, the fixed nature of the camera lens as well as its rigid unidirectional attribute presents a significant limitation for mobile communication device application innovation and use some of which could potentially save lives.

However, the current use of mobile communication device camera is limited to the capture angle capability of a fixed camera lens either forward facing or backward facing; this has a limited capture cone and the use for this camera type is limited hence mobile communication devices, mobile communication device applications are currently built around this fixed unidirectional camera lens. This unidirectional camera lens found in current mobile communication devices can only capture video feeds or images within its fixed cone and In order to capture video or images outside this capture cone, the user has to orient or move the mobile communication device appropriately; this limits the user's use of the camera in terms of capture range and numerous innovative application which could make use of a better technology. A common problem is when a mobile communication device camera user wants to take a photograph and has a line-up of capture targets outside capture cone, the user tends to move further away to be able to ensure that all of the capture target is within the capture cone; by so doing the capture target size is reduced hence it becomes more difficult to identify the elements that makes up the capture target within the frame, hence poor quality images or videos. Numerous mobile communication device safety applications whose effectiveness (which could potentially save lives) relies on the camera lens capture cone limits would hence be limited. The Mobile communication device multidirectional/wide angle camera lens system is able to solve this problem.

### BRIEF SUMMARY OF THE INVENTION

This is a system where a mobile communication device camera is able to capture a panoramic view either through a camera lens or system of lenses projecting (enclosed or not enclosed) beyond the camera surface in other to be able to capture a wide angle or panoramic view larger than what is possible by the traditional mobile communication device fixed unidirectional camera lens; or a system of camera lenses embedded within the body of the mobile communication device (enclosed or not enclosed). The angle covered by this system will allow wider angle video, live video, still image capture. It will also allow mobile communication device applications to innovate software applications which make use of the ability of the Mobile communication device multidirectional/wide angle camera lens system to pan and set camera lens view positions.

### BRIEF DESCRIPTION OF THE SEVERAL VIEWS OF THE DRAWING

FIG. 1 shows the camera lens capture angle video and camera for the mobile communication device multi directional/wide angle camera lens system in comparison with the traditional mobile communication device camera capture angle as viewed from the side of the device.

FIG. 2 shows the camera lens capture angle video and camera for the mobile communication device multi directional/wide angle camera lens system in comparison with the traditional mobile communication device camera capture angle as viewed from the top or bottom of the device.

FIG. 3 shows a projecting/protruding single or multiple camera lens system which can be movable (automatic and/or manual control) or static all within a transparent, semi-transparent or opaque enclosure of any shape size or form.

FIG. 4 shows a projecting/protruding single lens system which can be movable (automatic and/or manual control) or static and is not enclosed.

FIG. 5 shows a projecting/protruding multiple lens system which can be movable (automatic and/or manual control) or static and is not enclosed.

FIG. 6 shows a non-projecting/non-protruding single or multiple camera lens system which can be movable (automatic and/or manual control) all within a transparent, semi-transparent or opaque flat/semi protruding enclosure of any shape size or form.

FIG. 7 shows a non-projecting/non-protruding single lens system which can be movable (automatic and/or manual control) and is not enclosed.

FIG. 8 shows a non-projecting/non-protruding multiple lens system which can be movable (automatic and/or manual control) or static and is not enclosed.

FIG. 9 shows a mobile communication device with a spherical (or any other shape) camera lens system integrated anywhere along the side perimeter/edge of the mobile communication device.

FIG. 10 shows a mobile communication device with a protruding camera lens system of any shape integrated anywhere along the side perimeter/edge of the mobile communication device.

FIG. 11 shows a mobile communication device with two spherical (or any other shape) protruding camera lens systems integrated on the corners of the mobile communication device.

FIG. 12 shows a mobile communication device with two flushed (or any other shape) camera lens systems integrated on the corners of the mobile communication device.

### DETAILED DESCRIPTION OF THE INVENTION

This invention is a mobile communication device multi directional/wide angle camera lens system which relates to providing wider angle camera view capability to the device through repositioning and/or automating the camera lens. This is done in such a way that by projecting the lens beyond the body of the mobile communication device with or without automation, or by simply having multiple omni directional static lenses or a single movable lens without projection, the user of the device is able to capture a wider angle of video feed or image which was original impossible with the traditional unidirectional fixed lens mobile communication device camera.

The captured panoramic view is displayed on the user device in a format which is readable as desired by the user/reader/viewer of the display from the mobile communication device. The images that are displayed can also be controlled by the user of the mobile communication device to view a scene at an angle not directly opposite the panoramic camera but is within its coverage range.

The view on the mobile communication device can also be moved by finger gestures which a user makes on the display and/or controls of the mobile communication device.

The view can also be zoomed within set limits to allow a user see the angle they have positioned the panoramic camera of the device at.

The invention of this mobile communication device multi directional/wide angle camera lens system will now be described solely by way of example with reference to the accompanying drawings in which:

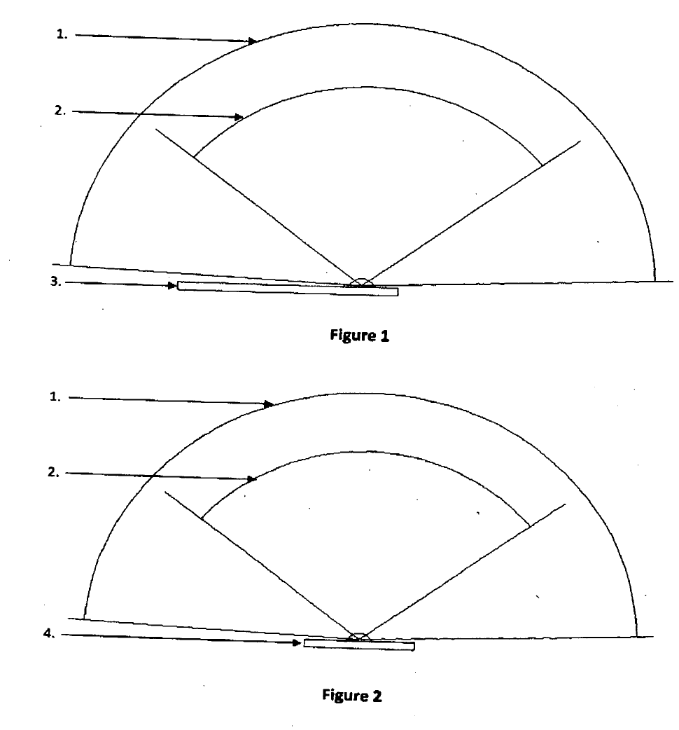

In FIG. 1, the landscape side view of a mobile communication device 3 with the panoramic capture angle of the mobile communication device multi directional/wide angle camera lens system 1 is illustrated in comparison with the capture angle 2 of a traditional mobile communication device which is displayed on the mobile communication device dependent on the extents the user chooses to view the scene currently being captured or an angle of the scene within the panoramic view. The user can then zoom in and out of the displayed view to suit their needs.

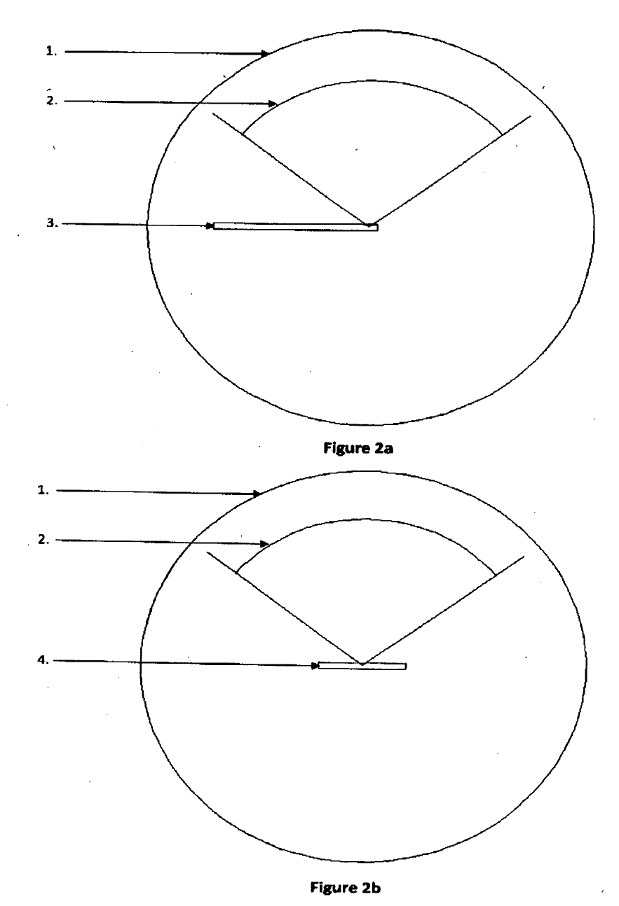

FIG. 2 shows the portrait side view of a mobile communication device 4 with the panoramic capture angle of the mobile communication device multi directional/wide angle camera lens system 1 is illustrated in comparison with the capture angle 2 of a traditional mobile communication device which is displayed on the mobile communication device dependent on the extents the user chooses to view the scene currently being captured or an angle of the scene within the panoramic view. The user can then zoom in and out of the displayed view to suit their needs.

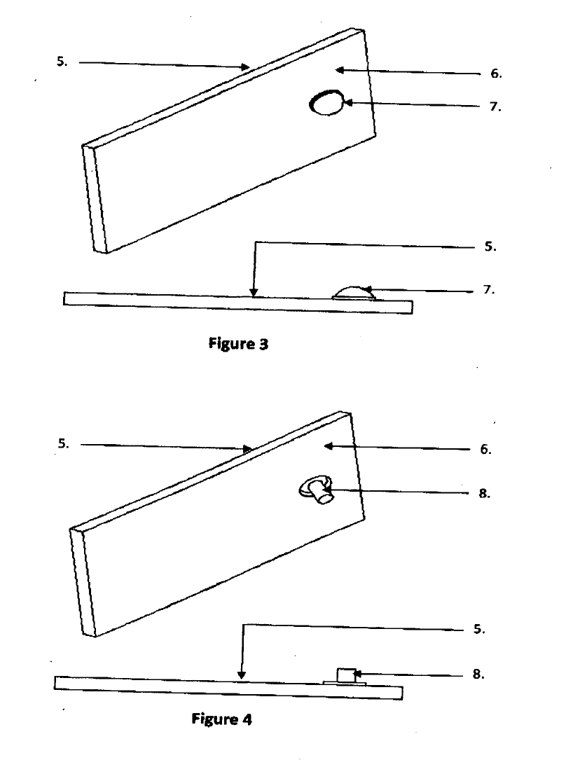

FIG. 3 shows the front 5 of a mobile communication device, the rear or back 6 of the mobile communication device and a projecting/protruding single or multiple camera lens system 7 which can be movable (automatic and/or manual control) or static all within a transparent, semi-transparent or opaque enclosure of any shape size or form.

FIG. 4 shows the front 5 of a mobile communication device, the rear or back 6 of the mobile communication device and a projecting/protruding single camera lens system 8 which can be movable (automatic and/or manual control) or static but is not closed off within the enclosure.

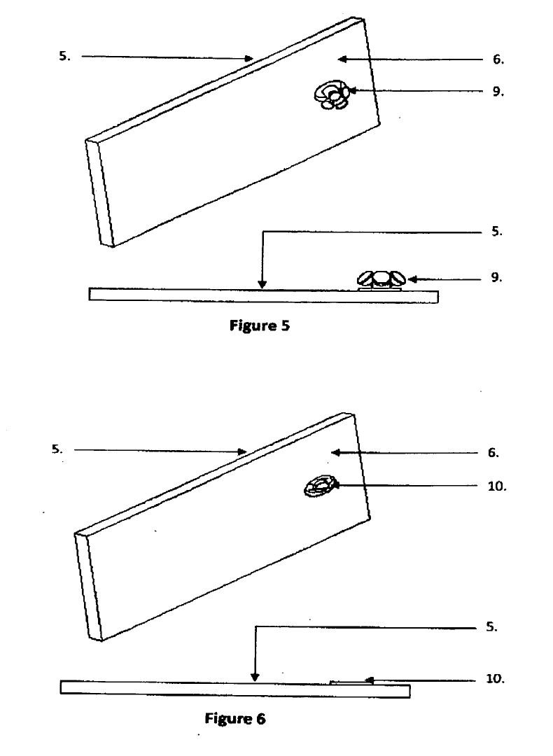

FIG. 5 shows the front 5 of a mobile communication device, the rear or back 6 of the mobile communication device and a projecting/protruding multiple camera lens system 9 which can be movable (automatic and/or manual control) or static but is not closed off within the enclosure.

FIG. 6 shows the front 5 of a mobile communication device, the rear or back 6 of the mobile communication device and a non-projecting/non-protruding single or multiple camera lens system 10 which can be movable (automatic and/or manual control) all within a transparent, semi-transparent or opaque flat/semi protruding enclosure of any shape size or form.

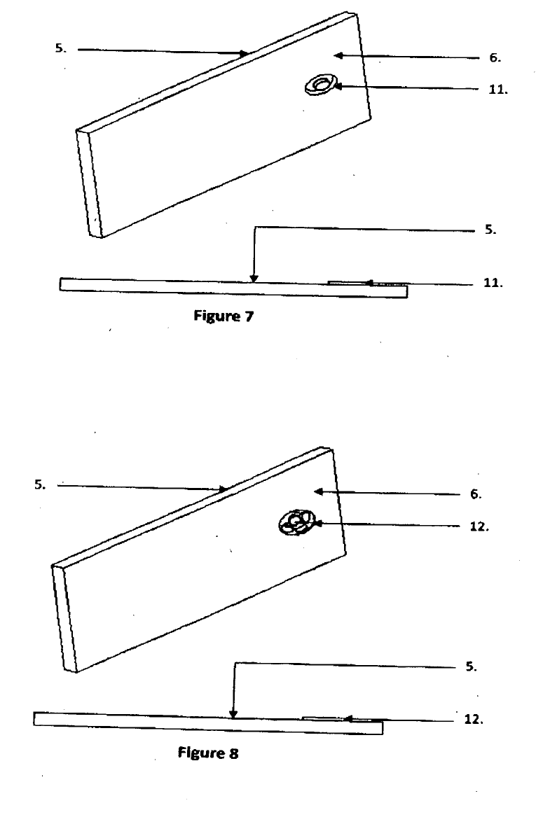

FIG. 7 shows the front 5 of a mobile communication device, the rear or back 6 of the mobile communication device and a non-projecting/non-protruding single camera lens system 11 which can be movable (automatic and/or manual control) and is not closed off within the enclosure.

FIG. 8 shows the front 5 of a mobile communication device, the rear or back 6 of the mobile communication device and a non-projecting/non-protruding multiple camera lens system 12 which can be movable (automatic and/or manual control) and is not dosed off within the enclosure.

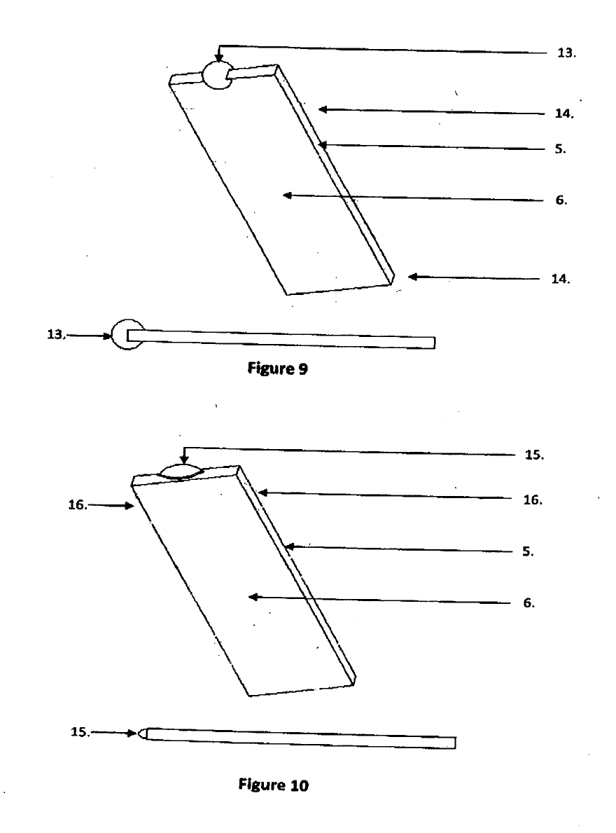

FIG. 9 shows the front 5 of a mobile communication device, the rear or back 6 of the mobile communication device and the integration 13 and possible placements 14 of a spherical protruding camera lens system on the side of the mobile communication device.

FIG. 10 shows the front 5 of a mobile communication device, the rear or back 6 of the mobile communication device and the integration 15 and possible placements 16 of a protruding camera lens system on the on the side of the mobile communication device.

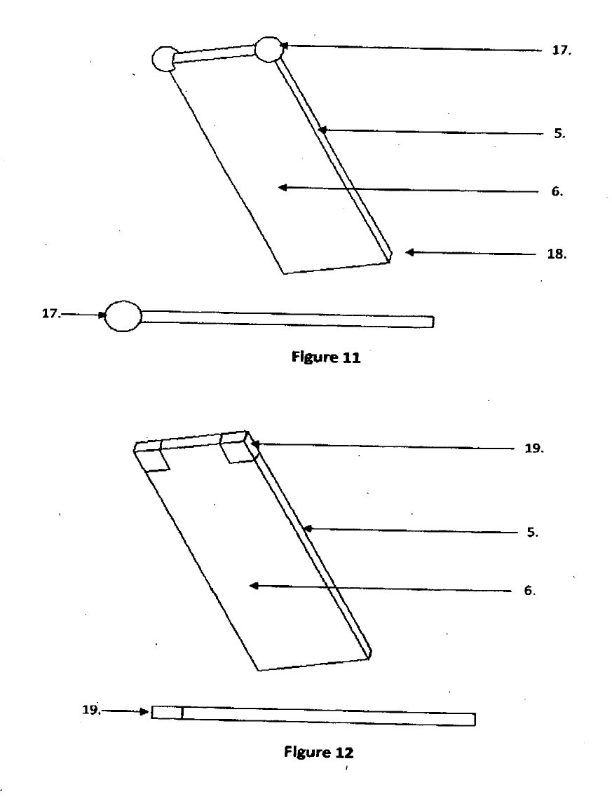

FIG. 11 shows the front 5 of a mobile communication device, the rear or back 6 of the mobile communication device and the integration 17 and possible placements 18 for a camera lens system that protrudes on the edges of the mobile communication device.

FIG. 12 shows the front 5 of a mobile communication device, the rear or back 6 of the mobile communication device and the integration 19 of a camera lens system which has been assimilated onto the diagonal edges of the mobile communication device.

1. A mobile communication device camera-capture system comprising:
a mobile communication device with one or more panoramic cameras;
with the capability to capture wide angle panoramic image or video made possible primarily by the projection from device shell, position along the edges and/or surface of the device and/or dynamic motion capability of the lens while projected/protruded or embedded within the mobile communication device;
control features using any proprietary or non-proprietary application on the device for controlling the panoramic view captured by the panoramic camera.

2. The system of claim 1 further comprising:
a panoramic camera with a camera lens system;
the panoramic camera is able to capture a 180 and/or up to a 360 degree view within the vertical and horizontal direction of the mobile communication device hence creating a full or partial 3D spherical and/or 3D panoramic capture/image;
the system is able to separately capture single or multiple snap shot portions within the 180 and/or up to a 360 degree full or partial 3D spherical and/or 3D panoramic capture/image;
the captured view is displayed in a comprehensible format for a user on the display of the mobile communication device;
the snapshot portions taken from the entire 180 and/or up to a 360 degree camera view can be snapshots of any pre-set moving object/s or person/s portion within the entire 180 and/or up to a 360 degree live camera range;
these snap shot portions can be saved in the mobile communication device or any other device as separate snap shots;
the angle of the captured view being controlled by the user of the mobile communication device within the prescribed extents of the panoramic view;
the captured view can be focused on just an angle within the view or the entire captured 180 and/or up to 360 degree view;
the captured view can be zoomed in and out to highlight more details of just an angle within the view.

3. The system of claim 1 further comprising:
a panoramic camera with a camera lens system;
the lens system is an enclosed non-projecting single or multiple lens unit;
the lens unit(s) is movable or static;
the movable lens unit(s) is automatically and/or manually controlled on the mobile communication device.

4. The system of claim 1 further comprising:
a panoramic camera with a camera lens system;
the lens system is a non-enclosed, non-projecting single lens unit;
the lens unit is movable or static;
the movable lens unit is automatically and/or manually controlled on the mobile communication device.

5. The system of claim 1 further comprising:
a panoramic camera with a camera lens system;
the lens system is an enclosed, non-projecting single lens unit;
the lens unit is movable or static;
the movable lens unit is automatically and/or manually controlled on the mobile communication device.

6. The system of claim 1 further comprising:
a panoramic camera with a camera lens system;
the lens system is a non-enclosed, non-projecting multiple lens unit;
the lens units are movable or static;
the movable lens units are automatically and/or manually controlled on the mobile communication device.

7. The system of claim 1 further comprising:
a panoramic camera with a camera lens system;
the lens system is an enclosed, non-projecting multiple lens unit;
the lens units are movable or static;
the movable lens units are automatically and/or manually controlled on the mobile communication device.

8. The system of claim 1 further comprising:
a panoramic camera with a camera lens system;
the lens system is an enclosed, projecting single or multiple lens unit;
the enclosed projection can be in any shape or size;
the lens unit(s) is movable or static;
the movable lens unit(s) is automatically and/or manually controlled on the mobile communication device.

9. The system of claim 1 further comprising:
a panoramic camera with a camera lens system;
the lens system is a non-enclosed, projecting single lens unit;
the projection can be in any shape or size;
the lens unit is movable or static;
the movable lens unit is automatically and/or manually controlled on the mobile communication device.

10. The system of claim 1 further comprising:
a panoramic camera with a camera lens system;
the lens system is a non-enclosed, projecting multiple lens unit;
the projection can be in any shape or size;
the lens units are movable or static;
the movable lens units are automatically and/or manually controlled on the mobile communication device.

11. The system of claim 1 further comprising:
a panoramic camera with a camera lens system;
the camera system can be found on any part, edge, surface or corner of the mobile communication device;
the camera system capable of displaying a three-dimensional image by coupling of the scenes currently being captured by the panoramic camera on the device.

12. The system of claim 1 further comprising:
a panoramic camera with a camera lens system;
the camera lens system projects out from its enclosure;
camera projection could be of any shape regular such as but not limited to spherical hemispherical oval, cube, cuboid, star shape, any of the polygon or any irregular/regular shape;
camera projection could be immovable or movable (along surface of communication device or rotation).

13. The system of claim 1 further comprising:
a panoramic camera with a camera lens system;
the camera lens system projects out from its enclosure;
the projection could be fixed to the edge, surface, corner of the mobile communication device or have a manual or an automatic retractable capability;
the projection can be triggered by the user and/or any other external (environmental, physical, electromagnetic, electrical, mechanical) or internal (phone application/software) factors.

14. The system of claim 1 further comprising:
a camera capturing communication device;
the camera lens system projects out from its enclosure; sensors within the projection for single or multiple lens system;
the lens system is static, pointed in any single or multiple directions, responsive to gyroscope or not responsive to gyroscope;
it is within an enclosure;
the enclosure of projection could be made of any transparent, semi-transparent or opaque material or a combination of materials.

15. The system of claim 1 further comprising:
a camera capturing communication device;
the camera lens system projects out from its enclosure;
sensors within the projection for single or multiple lens system;
the lens system is movable, pointed in any single or multiple directions, responsive to gyroscope or not responsive to gyroscope;
it is within an enclosure;
the enclosure of projection could be made of any transparent, semi-transparent or opaque material or a combination of materials.
